(19) United States
(12) Patent Application Publication
(10) Pub. No.: US 2010/0094775 A1
(43) Pub. Date: Apr. 15, 2010

(54) LIST EXECUTION AND CASH BALANCING

(76) Inventors: Henri WAELBROECK, Scarsdale, NY (US); Brent GAMSE, Glencoe, IL (US); Carla GOMES, New York, NY (US)

Correspondence Address: BLANK ROME LLP, WATERGATE, 600 NEW HAMPSHIRE AVENUE, N.W., WASHINGTON, DC, 20037, US

(21) Appl. No.: 12/575,116

(22) Filed: Oct. 7, 2009

Related U.S. Application Data
(60) Provisional application No. 61/103,736, filed on Oct. 8, 2008.
(60) Provisional application No. 61/104,458, filed on Oct. 10, 2008.

(51) Int. Cl. G06Q 40/00

(52) U.S. Cl. 705/36 R

(57) ABSTRACT

The present invention maintains a list of potential buy and sell opportunities tracking available liquidity at the best price displayed on the market in real time. When a block opportunity arises that would violate the constraints (e.g., cash balancing constraints), the subject system will consider if there are enough opportunities to trade on the market on the opposite side to bring the cash position back within the specified constraints. If cash balance can potentially be re-established by accessing displayed liquidity at the current best prices, the block execution is accepted and orders are automatically sent out to access this liquidity.

### REFERENCE TO RELATED APPLICATIONS

The present application claims the benefit of U.S. Provisional Patent Application No. 61/103,736, filed Oct. 8, 2008, and of U.S. Provisional Patent Application No. 61/104,458, filed Oct. 10, 2008. The inventions described herein relate to systems and methods for order management in financial trading, including improvements to the methods and systems described in US Application Publication Nos. US 2004/0059666 A1, US 2004/0210511 A1, US 2004/0034591 A1, US 2007/0271172 A1, US 2007/0276748 A1, US 2008/0021809 A1, US 2008/0040254 A1, and US 2008/0040255 A1. The disclosures of all of those applications are hereby incorporated by reference in their entireties into the present disclosure.

### FIELD OF THE INVENTION

The present invention is directed to automated trading and more particularly to automated trading that uses opportunistic strikes to comply with cash balancing or another constraint.

### DESCRIPTION OF RELATED ART

Program trading, also known as portfolio trading, is a generic term used to describe a type of trading in securities, specifically the simultaneous trading of a group of stocks. The term is often associated with computer aided transactions, portfolio insurance, and a kind of arbitrage between stock markets and stock index futures or options markets. For example, The New York Stock Exchange defines program trading as any trade involving fifteen or more stocks with an aggregate value in excess of $1 million, while the BMO “Investorline” glossary defines it as, “a sophisticated computerized trading strategy whereby a portfolio manager attempts to earn a profit from the price spreads between a portfolio of equities similar or identical to those underlying a designated stock index, e.g. the Standard & Poor's 500 Index, and the price at which futures contracts (or their options) on the index trade in financial futures markets”, while the US Commodity Futures Trading Commission defines it as, “the purchase (or sale) of a large number of stocks contained in or comprising a portfolio.”

When program trades are executed, the decision as to which trades to make is based purely on the price of the stocks to be traded in relation to each other on a predetermined basis, and not on any fundamental reason such as an individual company's earnings, dividends, or growth prospects; or on any overall economic reasons such as interest rate movements, currency fluctuations, or governmental or political actions. Therefore, program trades can be directed by any number of strategies, including duration averaging, portfolio insurance, or index arbitrage, and are often associated with a range of requirements; for example the requirement that the buys and sells be executed at roughly the same rate or that the executions maintain a low tracking error relative to a certain index.

In recent years, program trading has represented a large and increasing portion of market activity. Data gathered between November 2006 and February 2007 for a Greenwich Associates portfolio trading study showed that market wide, total portfolio trading volume jumped 52 percent to $2.1 trillion, from $1.38 trillion the previous year. Furthermore according to the same study, the average buy side institution saw a 50 percent increase in the dollar amount of program trading it executed in 2007 compared to the previous year. And, according to the 135 institutional equity buy side desks the Greenwich study surveyed; program trades represented roughly half of their total equity trading volume.

Industry experts cite a larger buy side trend towards “do-it-yourself” trading as a driving factor behind this significant increase in buy side program trading; while in turn this “self service” trend among buy side traders can be attributed in large part to a dramatic increase in the number and quality of trading technologies now available to the buy side. Buy side traders, once limited in their choices for how or where they could execute their own trades, now have direct access to an ever increasing selection of trading platforms and algorithmic trading products specifically designed to empower buy side traders with greater control over their trade executions.

Leading this explosion in buy side focused trading platforms has been a group of anonymous, large block execution systems including POSIT, LiquidNet and Pipeline. The Pipeline block execution system is described in part in US Application Publication Nos. US 2004/0059666 A1 and US 2004/0210511 A1. Each of these systems give buy side traders direct, anonymous access to deep pools of liquidity where they can execute large block trades with natural counterparties without exposing themselves to the levels of information leakage and market impact that plague more traditional platforms and exchanges. As a result, executions in these venues offer buy side traders significant reductions in the implicit trading costs associated with market impact and information leakage.

Furthermore, in addition to these buy side focused trading platforms, there has also been exceptional growth in the number of algorithmic trading products specifically designed to address buy side trading needs. Among the block execution platforms, Pipeline has lead the way with its Algorithmic Switching Engine, covered in US 2007/0271172 A1, US 2007/0276748 A1, US 2008/0021809 A1, US 2008/0040254 A1, US 2008/0040255 A1. Pipeline's Algorithm Switching Engine, along with the other buy side focused algorithmic trading products offered by the other block crossing platforms as well as traditional broker dealers and exchanges; offer buy side traders a range of trading strategies focused on impact free executions that offer significant reductions in both implicit and explicit trading costs by greatly reducing market impact, information leakage and trading delays that can drive up the costs often associated with large block orders.

However, even with this tremendous growth in buy side focused block execution and algorithmic trading products, and the simultaneous explosion in program trading—both specific to the buy side and market wide; existing trading products have failed to combine the requirements of large block executions with the strategies behind program trading. For example, with the existing combinations of block execution and algorithmic trading products, if the opportunity for a block execution arose for a stock within a program trade associated with a set of cash balancing constraints, and the dollar value of that block trade exceeded those cash balancing constraints, then the block execution would not take place and the trader would miss the opportunity for a lower cost, impact free execution.

### SUMMARY OF THE INVENTION

It is therefore an object of the present invention to solve this problem by enabling program trading that incorporates both block executions and the constraints associated with a given program trade through the automated evaluation and exploitation of opportunistic strikes. For example, for a given list of buy orders and sell orders associated with a set of cash balancing constraints, the subject system will track in real time the available liquidity at the best price displayed on the market for each buy and sell order on the list; while simultaneously seeking block execution opportunities for the same set of buy and sell orders. When an opportunity arises to execute a block trade that would violate the cash balancing constraints associated with the list of buy and sell orders, the subject system will use its real time evaluation of displayed liquidity for each of the buy and sell orders in the list to determine whether or not there are enough opportunities within the buy (or sell) orders on the list to trade on the market on the opposite side of the potential block execution to bring the cash position back within the specified constraints following the execution of the block. If the system projects that the cash balance could be re-established by accessing displayed liquidity at the current best prices, the block execution is accepted and orders are automatically sent out to access this liquidity.

### BRIEF DESCRIPTION OF THE DRAWINGS

A preferred embodiment of the invention will be disclosed with reference to the drawings, in which:

FIG. 1, which is a flow chart showing an overview of the preferred embodiment;

FIG. 2 shows a graphical user interface used in the preferred embodiment; and

FIG. 3 is a schematic diagram showing a system on which the preferred embodiment can be implemented.

### DETAILED DESCRIPTION OF THE PREFERRED EMBODIMENT

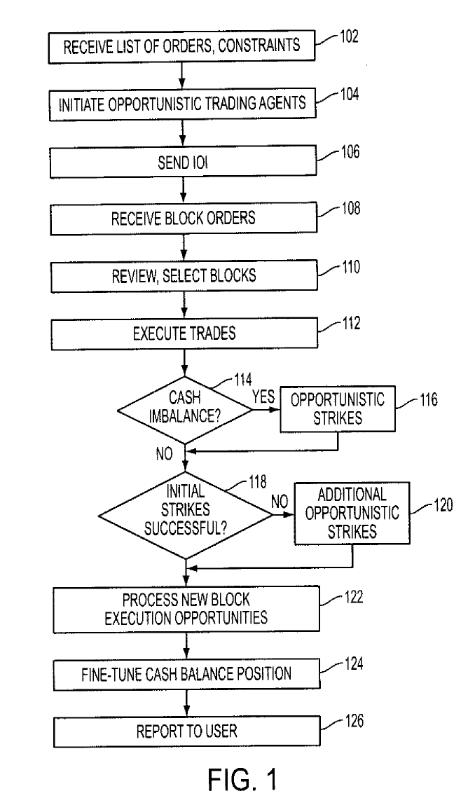

A preferred embodiment will be set forth in detail with reference to FIGS. 1-3.

### Definitions

Opportunistic Strike: the ability to execute an order using available/displayed liquidity either at a single moment in time, i.e. purchasing a certain number shares on the market at the available price at a certain moment in time or over a specific period of time, i.e. using a high speed algorithm to purchase all available shares on the market for 60 seconds as long as the price stays within a specific tactical limit. This definition must encompass both point-in-time and period-of-time execution parameters because some stocks have very little size at the inside quote at any given moment, and therefore require a longer period of time to enable the accumulation/display of adequate liquidity.

Buy/sell imbalance: Measures the current dollar to dollar imbalance or ratio imbalance in [$] for the buys and sells separately.

Opportunity score: Measures the value of a “Fast Forward” opportunity on a given name; in other words it is a representation of how effective it would be to use the subject system's Algorithm Switching Engine's “Fast Forward” feature, (as described in US Application Publication Nos. US 2007/0271172 A1, US 2007/0276748 A1, US 2008/0021809 A1, US 2008/0040254 A1, US 2008/0040255 A1), wherein the engine quickly buys or sells all available (or a certain quantity) of the stock at the bid or the offer. In a preferred embodiment the definition of “effective” is a reflection of the market impact that would be caused by buying or selling a certain quantity of the stock over a certain period of time, but could also mean any other number of factors used to judge trading efficiency as known to those skilled in the art. The Opportunity Score is a real number in (0, 1). Opportunities will be classified as level 1, 2 or 3 based on the user's dollar imbalance thresholds, where Level 1 represents the best opportunity and Level 3 is to be exercised only if absolutely needed to regain balance.

Buyable/sellable quantity at level n: The estimated $ value in all names with level n opportunities that can be bought/sold by exercising the opportunity, as can be estimated from the displayed quote size and historical data.

Large Block Quantity (LBQ): a system defined minimum quantity that constitutes a block order, for example an LBQ could be 5,000, 25,000 or 100,000 shares.

Percent of Available Liquidity (PAL): Measures the order size as a percentage of the estimated remaining trading volume from the current time to the end of the trading session. The estimated remaining volume can be calculated using methods known in the art based on the historical volume profile through the day (“smile” curve), average daily volume for the stock and current volume observations.

Timed Events: Initiation of a system computation based on the expiration of a specified amount of time.

Arrival Price: Midpoint price between the best bid and best offer price, at the time the order is received.

Safe Mode: Mode of execution of the preferred algorithmic execution system when the stock has been affected by unusual market effects, such as returns in excess of one standard deviation based on the stock's historical volatility.

Participation Rate: Ratio between the number of shares an algorithm fills, and the number of shares traded in the market overall in the same period of time.

A summary of a preferred embodiment of the subject invention is described below and illustrated in the flowchart of FIG. 1 using cash balancing as the example restraint. However it is important to note that other hard constraints besides cash balancing are known to those skilled in the art and can be enforced using the subject system; the buyable/sellable quantity described herein readily generalizes to a measure of the impact of opportunistic strikes on the constraint in question and the acceptance of block opportunities is subjected to the ability to enforce the hard constraint after execution of selected opportunistic strikes.

In step 102 a list is received into the system comprising buy orders, sell orders and cash balancing instructions; the total $ value of buys and sells is calculated based on current market prices and compared to the cash balancing instructions.

In step 104 opportunistic trading agents are initiated and report back with opportunity scores and the buyable/sellable quantity for each of the orders contained in the list.

In step 106 an indication of interest message is sent to one or more block marketplaces or other repositories of block orders such as order management systems. This step of indication of interest message distribution can use any number of methods for indication of interest distribution as known to those skilled in the art, or the systems and methods described in US 2004/0034591 A1 and U.S. patent application Ser. No. 12/463,886.

In step 108 block orders are received from the block marketplaces or other repositories of block orders in response to the indication of interest message distribution in step 106 and stored in a buffer for processing.

In step 110 the block trade opportunities received in step 108 are reviewed to determine which blocks can be accepted while remaining close enough to the cash balancing objectives such that the cash balance can be re-established using only opportunity scores of 2 or better, as determined for each order in the list in step 104.

In step 112 the block trades selected in step 110 are executed. The subject system then checks in step 114 to determine if there is a cash imbalance following the completion of the block executions. If there is an imbalance, algorithms are used in step 116 to launch opportunistic strikes designed to return the cash balance to a threshold within the client's specific limits.

In step 118 the cash balance position is re-evaluated after the opportunistic strikes launched in step 116 are completed. If the initial set of strikes was successful, i.e. able bring the cash balance back inside the thresholds set by the user, the system proceeds to step 122.

However, if the strike was not entirely successful, the subject system will initiate additional opportunistic strike(s) in step 120. These additional strikes utilize a participation rate determined by the system as the ideal rate to correct the remaining imbalance over a specified period of time, i.e. within the next five minutes. In selecting this rate, the system uses current market conditions and historical data to project the costs that would be incurred by each rate within a set of rates if it were used to reestablished the cash balance objectives within the specified period of time. Once it has made those projections; the system selects the rate which it projects will regain the necessary balance within the specified period of time while incurring the lowest execution costs.

In step 122 new block execution opportunities are processed in batch mode as previously described for steps 110-120.

In step 124 the system “fine tunes” the cash balance position following a timed cash balance check event. Based on the results of the cash balance check, the system initiates opportunistic strikes and/or participation rate adjustments to ensure the cash balance is as close to the established cash objective as possible. In this step, only opportunities with an opportunity score of 1 are executed, and only if they do not cause a worsening of the cash position; while opportunities with an opportunity score of 2 are held in reserve to be used for restoring cash balance following a level 1 opportunity or block execution.

In step 126 the results of the trade(s) are reported back to the user.

In an alternate embodiment of the subject invention the user is enabled to request “soft” constraints or optimization objectives in addition to the hard constraint. In this alternate embodiment a cost function is specified in addition to the hard constraint. It is common to use the implementation shortfall cost with additive terms representing the risk factors as this cost function, but other cost functions can easily be imagined by those skilled in the art. When this additional “soft constraint” is added, the algorithm participation rates are calculated to minimize the expected value of the cost function looking ahead five minutes, while simultaneously enforcing the hard constraints, as can be implemented using any of the constrained optimization algorithms known in the art.

Block opportunities generally tend to reduce the expected shortfall because they are executions at the current market prices, i.e. with no market impact, but they may increase other risk factors; therefore when an additional soft constraint is added in this alternate embodiment, the decision to accept or reject block opportunities that can meet the hard constraint as described in the preferred embodiment in step 122 is further subjected to the additional step of re-calculating optimal participation rates and checking that the expected cost for the re-optimized implementation plan is not larger than it would have been had the block executions not been accepted. Block execution opportunities that increase expected risk-adjusted cost are then rejected.

As will be clear to those skilled in the art, various implementations of the above invention can be construed. Below we describe one possible implementation for completeness.

To begin the process, the subject system receives a list comprising buy orders, sell orders and cash balancing constraints. The system can receive the list by any method known to those skilled in the art, here are examples of two potential methods whereby the subject system receives the list and imbalance thresholds:
a. The user uses a graphic user interface (GUI) to submit manually the list of orders and to specify manually a dollar imbalance threshold for the BUY orders on the list and the SELL orders on the list.
b. The subject system pulls the list of orders and/or the associated dollar imbalance thresholds from user's Order Management System, Execution Management System or any other type of order management system as known to those skilled in the art which can be integrated with the subject system such that the subject system may pull said information from said order management system freeing the user from the need to manually enter the list of orders and/or the dollar imbalance thresholds for the BUY orders and SELL orders on the list.

As soon as subject system receives the list and the associated constraints, the system calculates the $ value of all buys and the $ value of all sells. Then it uses these $ value calculations to determine the current cash balance where Cash=current cash balance. Let Buy_0 be the buyable quantity, Buys the amount we will try to buy, and similarly for Sells_0 and Sells. The objective is to have Cash=Buys−Sells. If Sells_0>Buys_0−Cash, then choose Buys=Buys_0 and Sells=Buys_0−Cash. Else choose Sells=Sells_0 and Buys=Sells_0+Cash

The system maintains the calculation of the existing dollar imbalance for the buys and sells separately. This cash balance will be reviewed periodically at pre-determined time intervals and on the arrival of block opportunities, following block executions or on balance check triggering events; preferably with a randomized timer delay between 40-80 seconds.

The subject system aims to enforce a constraint as a program trade is executed. Several constraints are known in the art; perhaps the most important example is cash balancing. The preferred embodiment supports two types of cash balance constraints, known in the art as “dollar-for-dollar” balancing and “ratio” balancing, which we describe next.

The subject system can readily be extended to enforce other constraints known in the art, and to minimize a cost function that embodies “soft constraints” or optimization objectives such as factor tracking and implementation shortfall reduction. It will be readily apparent to those skilled in the art how the subject invention generalizes to implement soft constraints by estimating 5-minute look-ahead positions with or without block fills and committing to the alternative that minimizes expected cost.

The residual % is z=100(residualBuys+residualSells)/(initialBuys+initialSells)

For ratio balancing, the buy and sell imbalances are defined as follows:

Buy imbalance=z*initialBuys−residualBuys
Note: The imbalance is positive if the purchases were too fast, i.e. there are less residual buys than expected according to the ratio z

Sell imbalance=z*initialSells−residualSells For Dollar-to-Dollar balancing, the term “imbalance” will refer to the nominal value of shares bought minus the nominal value of shares sold.

Once the system has received the list and determined the existing cash balance, it initiates opportunistic trading agents whose function is to scan one, some or all available markets in order to assess currently available/displayed liquidity for each of the securities contained in the list and to report back with opportunity scores and the buyable/sellable quantity for each security on the list.

These opportunistic agents calculate the opportunity score for a given security using the following parameters:

Initialize at 0, add 0.125 for each of the below conditions (inclusive):

price is not in safe mode.

price is better than arrival price.

price is better than S_{—}{½}

price is better than S_1 lagging participation rate(*) is below MinAcceptableRate threshold

lagging participation rate(*) is below PostContinuationRate threshold
add 0.125×Min(PAL, 35%)/10%
add 0.125×(1−2*exp(−t/T)) where T=300 seconds and t is the time [sec] elapsed since the last strike in that name; this discourages multiple strikes before the information content of a first strike has been dissipated.

(*) Initialize tape counter and available shares counter to 0 on start of an order. On fill or expiration event, if out of the money then reset tape counter to 0; else add tape counter to available shares counter for the order. Lagging participation rate is the ratio of shares filled to the available shares.

Then using the opportunity scores returned in the preceding step, the same opportunistic agents calculate the buyable/sellable quantity for each order on the list at level “n” opportunity score using the following parameters: The $ value in all names with level n opportunity score that can be bought/sold assuming the quantity that can be bought/sold is equal to 1.8 (configurable) times the displayed quantity on the offer/bid, or if this cannot be determined, NumSeconds=60 seconds (configurable) of available liquidity in the stock. The available liquidity is determined as ADV*(SVD(t+NumSeconds/60)−SVD(t)).

Once the opportunistic agents have returned opportunity scores and buyable/sellable quantities, subject system sends indications of interest to one or more block marketplaces or other repositories of block orders such as order management systems (OMSs) and Execution Management Systems (EMSs) in order to solicit contra orders for all of the buy (sell) orders on the list. In an alternate embodiment, indications of interest are only sent for block orders that can be executed without violating cash constraints after opportunistic strikes. In another alternate embodiment no indications are sent.

The block marketplaces and OMSs/EMSs included in this solicitation for block orders may or may not include, and is not limited to the subject system's block execution facility as well as the OMSs and EMSs of the subject system's own users. Furthermore, this step of indication of interest message distribution can use any number of methods for indication of interest distribution as known to those skilled in the art, or the systems and methods described in US 2004/0034591 A1 and 12/463,886.

After the subject system has sent out order solicitations, it receives block orders in response to the solicitations from the block marketplaces or other repositories of block orders and stores these block orders in a buffer for processing. The subject system then processes these stored block orders to determine which blocks can be accepted and executed while remaining close enough to the cash balancing constraints associated with the list such that the cash balance can be re-established using only opportunity scores of 2 or better.

This step of processing the block orders stored in the buffer is executed as a batch-process (e.g. using a 1-second-cycle spinning agent), in order to process list-crossing opportunities as unique events. Batch processing is a critical element in the subject system's method of executing blocks as part of a program trade because there is always the possibility that a plurality of block opportunities arrive within a second or a few seconds. When this happens, batch processing gives the system the opportunity to maintain cash balance through the execution of block orders in a balanced manner; leaving opportunistic strikes as a tool for balancing the residual after the blocks are executed. If the system did not batch process, it in instances of multiple block opportunities, it could potentially “use up” all of the opportunistic strike “ammunition” on the first block, leaving it unable to accept any more blocks.

Finally, the stored block orders are also sorted in two lists, one containing block buy opportunities and the other containing block sell opportunities. Each list is then sorted in descending order of Percent of Available Liquidity (PAL).

The task of identifying the optimal subset of buy and sell blocks that can be executed while remaining close enough to cash balance that the balance can be re-established through the use of opportunistic strikes, is a bin packing problem for which algorithms are known in the art. For completeness we describe next an example of an easy-to-implement algorithm that is suited to the present circumstances and computationally efficient.

In determining which of the stored block orders are acceptable for execution, the subject system starts with the buy and sell orders with the highest percent of available liquidity (PAL) ratings, and systematically assesses each order to determine if it is possible to execute the order and remain within the client's specified imbalance limits cash balance threshold either without the use of an opportunistic strike or only using strikes based on maximum sellable (buyable) quantities with an opportunity scores of 2 or better, as further specified in the following paragraphs. While the buy imbalance is positive, the system draws from sell queue; otherwise it draws from buy queue.

When assessing block orders from the relevant queue, the subject system commits to executing the largest number of Large Block Quantities (LBQs) from each order that it projects would leave the imbalance following execution of the block(s) within an absolute threshold equal to the maximum buy (sell) imbalance specified by the trader plus the maximum sellable (buyable) quantity with an opportunity score of 2.

If the subject system projects that the execution of one block with the highest PAL would exceed said absolute threshold, then it holds the proposed block in a temporary cache and attempts to find a block from the opposite queue to which it can also commit in order to obtain a projected cash balance within constraints associated with the list. If the subject system is able to locate a block on the opposite side whose execution would bring the imbalance within the absolute threshold, the subject system commits to both the cached block and the block on the opposite side and resumes drawing as above until it gets to the end of the list of stored block orders.

If the imbalance, assuming execution of the cached trades, exceeds the threshold in the opposite direction, then the subject system places the second block in the in temporary cache along with the first block and continues in its attempt to locate block(s) on the opposite queue that it projects would re-establish balance. If the subject system locates additional blocks that it can add to the cache that it projects would bring the projected imbalance within the absolute threshold, then it commits to executing the cached blocks and resumes drawing until it gets to end of the list of stored block orders. If at any point the subject system projects that adding a new block to the cache would overshoot the imbalance, the subject system simply moves back to the other queue and draw towards re-establishing balance, etc.

If the subject system has reached the end of the queue on the opposite side of the imbalance or if the queue is empty and the cached blocks fail to satisfy the cash balance constraints, then the subject system drops the cache and proceed with previously-committed blocks only.

In a preferred embodiment, the system is designed to “lock” the block opportunities while the above algorithm is implemented. During this lock phase, should a market participant elect to request a cancel of a block order under “active” consideration by the system for execution in cash-balance cross, the cancel is held in a pending state until the status of the order is resolved. This ensures that the block trade opportunities being considered in the cash-balanced cross can in fact be executed. Pended cancel requests from the market participant are processed after the list cross event has been completed.

In an alternate embodiment this lock is not enabled and the list cross event proceeds under the optimistic assumption that all blocks are in fact executable; should some executions fail to occur because of orders canceled during the evaluation process (of for any other reason), the event may result in a cash imbalance that cannot be eliminated through the initial set of opportunistic strikes. In that event, the system will then endeavor to re-establish balance through the execution of a second set of opportunistic strikes with participation rates chosen to r-established the balance as explained below.

Once the subject system has exhausted the list of stored block orders and committed to the tradable orders, it executes the committed block orders. After the status of the block executions is ascertained, the subject system calculates the imbalance in order to determine what, if any, opportunistic strikes may be needed to restore balance.

If there is an imbalance following the block executions, in order to restore balance the subject system directs the Algorithm Switching Engine to initiate an opportunistic strike as described in more detail in the next paragraph.

In directing the Algorithm Switching Engine to launch opportunistic strikes, the subject system uses the following parameters: if the imbalance is between ⅓ and ⅔ of the way to the client-specified limit, the subject system directs the Algorithm Switching Engine to launch a strike with total $ quantity limited to the lesser of the amount buyable (sellable) at level 1 or the amount needed to return to perfect balance. The names involved in this strike are drawn from the top of the list of ranked opportunities until the required cash amount is accrued.

If the imbalance is between ⅔ and 1× the limit, the subject system directs the Algorithm Switching Engine to launch a strike for the lesser of the amount buyable (sellable) up to level 2 or the amount needed to return to ⅓ of the client's limit.

If the imbalance is above the client's specified threshold, then the subject system directs the Algorithm Switching Engine to launch a strike with the lesser of the amount buyable (sellable) up to level 3, or the amount needed to return to ⅔ of the client's limit.

To execute a strike for a specific dollar amount x, the subject system ranks the buy (sell) opportunities on the list by descending order of the opportunity score. Then it assigns shares to each opportunity, taking 1 minute's worth of liquidity in the stock or the amount needed to reach the total required amount x (aggregate over all stocks involved in the strike). Then the subject system uses the Algorithm Switching Engine to execute each order using the Engine's “fast forward” feature, with each order limited to the current NBBO. If at the expiration of the last strike, the imbalance remains outside the client's specified limit, the subject system directs the Algorithm Switching Engine pause on the faster side as described in the following paragraph until the next cash balance review.

In the event the initial set of opportunistic strikes are not sufficient to re-establish a cash balance within the user's threshold; additional strikes are launched based on adjustments to the participation rates across the list as necessary (described in detail below) aiming to re-establish balance over time.

Slow-Downs following strikes with insufficient results: If the imbalance is between ⅓ and ⅔ of the way to the client-specified limit after expiration of the initial opportunistic strike, the subject system directs the Algorithm Switching Engine to pause the execution of names drawn from the list of ranked opportunities at level 3. The maximum cash balance correction resulting from a pause is estimated based on five minutes worth of liquidity at the current participation rate. The goal of this pause is to re-establish balance in no more than five minutes.

If the imbalance is between ⅔ and 1× the client-specified limit after expiration of the strike order, the subject system directs the Algorithm Switching Engine to pause execution of the names selected above as needed to return to ⅓ of the client's limit within five minutes.

If the imbalance is above the client's specified threshold after expiration of the strike order, then the subject system directs the Algorithm Switching Engine to pause execution of names drawn from the bottom of the list of ranked opportunities as needed to return to ⅔ of the client's limit in five minutes, with no restriction on the level.

Alternate embodiments employing different algorithms to re-establish cash balance after blocks are committed can be imagined by those skilled in the art. Preferred embodiments link the acceptance of block opportunities to the expected outcome of the chosen cash-restoring algorithm, so that blocks are only accepted if the outcome after cash balance corrections improves over the outcome that would have resulted without block executions. In the above, we have implicitly assumed that the over-riding goal is to execute the list without excessive impact, as reflected in the preference for executing as many blocks as possible while allowing only opportunistic strikes at the current best quoted prices; alternate embodiments evaluate the outcomes with and without block executions by calculating the estimated positions five minutes ahead counting implementation shortfall and soft constraints and electing to accept block executions only if the expected forward cost is minimized and hard constraints (cash balance) are strictly satisfied.

Once a batch of block execution opportunities are executed with the ensuring opportunistic strikes and the cash balance has been re-established within the client's specified limits, the next batch of block orders is processed following the same method. After all available batches of block orders have been processed, or at pre-determined time intervals or following balance check triggering events; the system will initiate a cash balance check event for the purpose of “fine tuning” the cash balance position. Based on the results of the cash balance check, the system initiates additional opportunistic strikes and/or participation rate adjustments in the manner previously described to ensure the cash balance is as close to the established cash objective as possible. However in this step, only opportunities with an opportunity score of 1 are executed, and only if they do not cause a worsening of the cash position; while opportunities with an opportunity score of 2 are held in reserve to be used for restoring cash balance following a level 1 opportunity or block execution.

Finally once the system has processed all available block orders and the ensuing strikes, the system reports the results of the trade(s) back to the user.

User Interface—Look and Feel

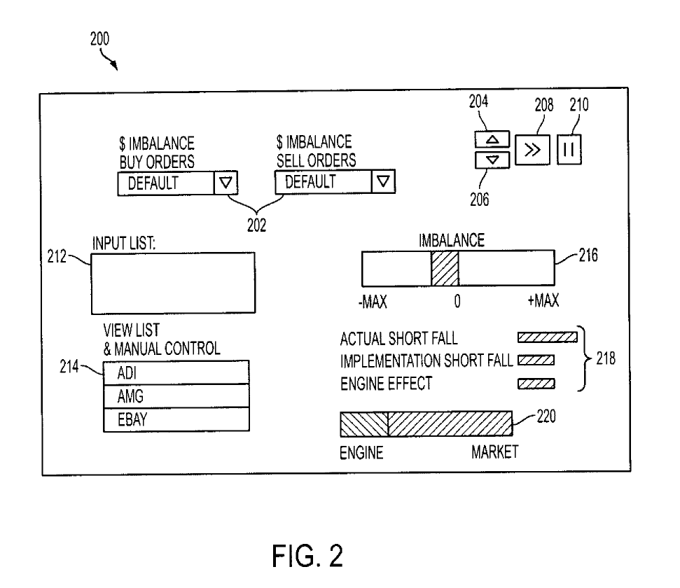

An important element of the subject system is the system's graphic user interface (GUI), shown in FIG. 2 as 200. Traders can use this interface to perform a number of functions, including making independent selections for the $ imbalance allowed for buy orders and sell orders within a list of orders, e.g., with drop-down menus 202 or any other suitable GUI element. While a trader can make his own selections, the subject system will set the default $ imbalance to: Max(10% original value of the list (buys+sells)).

The user interface also contains controls that enable the user to control and adjust the pace that the Algorithm Switching Engine is using to execute orders; thereby giving the user the ability to override manually the directions given to the Algorithm Switching Engine by the subject system. These controls are similar to those described for the Algorithm Switching Engine in US 2007/0271172 A1, US 2007/0276748 A1, US 2008/0021809 A1, US 2008/0040254 A1, US 2008/0040255 A1, all of which are hereby incorporated by reference.

These controls include but are not limited to, the ability to speed the pace with button 204, the ability to slow the pace with button 206, and performing a “fast forward” (as described in the definition section in the definition of an “opportunistic strike”) using button 208, and the ability to temporarily stop the executions or to cancel orders using button 210. Speed change selections will apply to paused stocks if and when the pause is cancelled and executions resume. To execute a “fast forward,” the buyable/sellable quantities are determined according to the calculations previously provided for the determination of buyable/sellable quantities.

Traders can also use the GUI to input a list (e.g., in box 212) and to assume manual control of any individual name on the list (e.g., in box 214). Names that are under trader control will not be subject to opportunistic strikes or pausing by the subject system, but the subject system will continue to try to maintain balance over the entire list including both the stocks on manual control and stocks being managed by the subject system. If a trader cancels an order from the list, the subject system will ignore that symbol in subsequent calculations of residualBuys, residualSells, initialBuys and initialSells and re-evaluate the imbalance.

Whenever a trader uses the GUI to make any change to the settings, the subject system automatically initiates a cash balance review previously described. Likewise, if an order is canceled from a list, the system automatically re-evaluates the cash balance ignoring the cancelled name.

In addition to offering the trader manual controls, the GUI also provides the traders with graphic images that detail the buy and sell imbalance as a portion of the maximum imbalance allowed, as shown in box 216.

Furthermore, the user interface also shows, in area 218, the execution performance of the list displayed as value-weighted averages [in bps] of:

Actual implementation shortfall (weights based on number of executed shares)

Implementation shortfall of the residual basket (weights based on number of shares to be executed)

“Engine Effect” which is a flat average of the participation rate of the algorithms performing the opportunistic strikes and the percentage of the list that has already been executed.

And finally, the subject system GUI can also display a graphic element 220 representing the manner in which shortfall breaks down into engine effect and market effects.

Multiple Lists

It is important to note that the subject system enables users to enter single lists or multiple lists. In the event a user chooses to enter multiple lists, the GUI enables the user to set and modify different parameters for each of the lists he enters.

In the cases where a client has FIX only Access:

FIX clients that support the FIX list protocol will be able to specify a list identifier. In other cases the system will assign a list identifier to orders entered within 10 seconds [configurable system-wide parameter] of each other. The help desk will show the list identifiers and enable the operator to view and edit current parameter settings for each list.

FIX only users will choose either ratio balancing or dollar to dollar balancing on each list. Once a user selects ratio or dollar to dollar balancing, a trader can use the GUI to modify the parameters for each set of constraints in the course of the execution, but once a list is assigned a type of constraint he cannot change from dollar for dollar to ratio balancing or vice versa. In the event a trader wants to change the type of constraint, he/she will need to cancel the list and re-enter with the new parameters.

Diagnostics/Logs:

Logs should show the following information to enable intraday diagnostic and analysis. This information does not need to be data warehoused. All trader requests and parameter changes must be displayed in the trapview logs with a description of the event.

On cash balancing event, write a record to the log file with

i) z, buy imbalance and sell imbalance or ii) dollar to dollar imbalance.

strike target $ and achieved $.

slowdown target $

shares pending (not committed) to block opportunities

On route event or routed order cancel/pause, indicate cause=“cash strike” or cause=“cash pause” or cause=“cash resume”

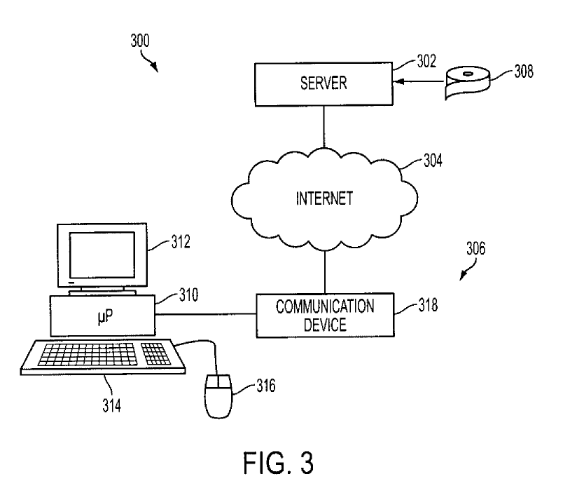

FIG. 3 shows a block diagram of a system 300 on which any of the disclosed embodiments can be implemented. A server 302 communicates over the Internet 304, or another suitable communication medium, with a user's computer (or other device such as a Web-enabled cellular telephone) 306. The software to implement any of the embodiments can be supplied on any suitable computer-readable medium 308. The computer preferably includes a microprocessor 310, a display 312 for displaying the user interface described herein, input devices such as a keyboard 314 and a mouse 316, and a communication device 318, such as a cable modem, for connecting to the Internet 304.

While a preferred embodiment and alternative embodiments have been set forth in detail above, those skilled in the art who have reviewed the present disclosure will readily appreciate that other embodiments can be realized within the scope of the invention. For example, numerical values are illustrative rather than limiting. Therefore, the invention should be construed as limited only by the appended claims.

What is claimed is:

1. A method, implemented in a computing system or network, for trading items, the method comprising:
(a) receiving, from a market participant, a plurality of orders and at least one constraint on execution of said orders;
(b) initiating an automated process to execute said orders using algorithms and/or block markets;
(c) automatically identifying buy/sell opportunities on the computing system or network or on systems in communication with the computing system or network, wherein said buy/sell opportunities are either at a point in time or aggregated over a period of time; and
(d) initiating opportunistic strikes to capture said buy/sell opportunities as needed to enforce said constraints.

2. The method of claim 1, wherein each of the orders is executed only if it is possible to enforce the at least one constraint through the opportunistic strikes on the buy/sell opportunities.

3. The method of claim 2, wherein step (c) comprises assigning opportunity scores to the buy/sell opportunities, and wherein step (d) comprises selecting the buy/sell opportunities in accordance with the opportunity scores.

4. The method of claim 3, further comprising:
(e) automatically determining whether the opportunistic strikes in step (g) have satisfied the at least one constraint; and
(f) if the at least one constraint has not been satisfied, automatically executing additional opportunistic strikes using additional ones of the buy/sell opportunities to satisfy the at least one constraint.

5. The method of claim 4, wherein step (f) is performed iteratively.

6. The method of claim 5, wherein step (f) is performed iteratively at a rate selected to minimize execution costs.

7. The method of claim 4, further comprising:
(g) automatically trading additional ones of the block trade opportunities; and
(h) automatically trading additional ones of the buy/sell opportunities to cause closer compliance with the at least one constraint.

8. The method of claim 1, wherein the at least one constraint comprises a hard constraint.

9. The method of claim 8, wherein the hard constraint comprises a cash balancing constraint.

10. The method of claim 9, further comprising automatically determining periodically whether the cash balancing constraint is met.

11. The method of claim 8, wherein the at least one constraint further comprises a soft constraint.

12. The method of claim 11, wherein the soft constraint comprises an optimization objective.

13. The method of claim 12, wherein the optimization objective is based on a cost function.

14. The method of claim 13, wherein the cost function is implemented through a look-ahead.

15. The method of claim 2, wherein each of the buy/sell opportunities is given the opportunity score in accordance with whether the buy/sell opportunity meets a plurality of criteria.

16. The method of claim 15, wherein the plurality of criteria comprise a price criterion.

17. The method of claim 15, wherein the plurality of criteria comprise a participation rate criterion.

18. The method of claim 1, further comprising providing a graphical user interface to the market participant, wherein step (a) is performed through the graphical user interface.

19. The method of claim 18, wherein the graphical user interface allows the market participant to specify the at least one constraint.

20. The method of claim 19, wherein the graphical user interface provides a default option for the at least one constraint.

21. The method of claim 18, wherein the graphical user interface allows the market participant to control a speed of trading.

22. The method of claim 18, wherein the graphical user interface provides a graphical display regarding whether the at least one constraint is met.

23. The method of claim 1, further comprising automatically determining periodically whether the at least one constraint is met.

24. A system for trading items, the system comprising:
a communication device for communicating over a computer network; and
a processor, in communication with the computer network, configured for:
(a) receiving, from a market participant, a plurality of orders and at least one constraint on execution of said orders;
(b) initiating an automated process to execute said orders using algorithms and/or block markets;
(c) automatically identifying buy/sell opportunities on the system or on other systems in communication with the system over the computer network, wherein said buy/sell opportunities are either at a point in time or aggregated over a period of time; and
(d) initiating opportunistic strikes to capture said buy/sell opportunities as needed to enforce said constraints.

25. The system of claim 24, wherein the processor is configured such that each of the orders is executed only if it is possible to enforce the at least one constraint through the opportunistic strikes on the buy/sell opportunities.

26. The system of claim 25, wherein the processor is configured perform step (c) by assigning opportunity scores to the buy/sell opportunities, and to perform step (d) by selecting the buy/sell opportunities in accordance with the opportunity scores.

27. The system of claim 26, wherein the processor is further configured to perform:
(e) automatically determining whether the opportunistic strikes in step (g) have satisfied the at least one constraint; and
(f) if the at least one constraint has not been satisfied, automatically executing additional opportunistic strikes using additional ones of the buy/sell opportunities to satisfy the at least one constraint.

28. The system of claim 27, wherein the processor is configured to perform step (f) iteratively.

29. The system of claim 28, wherein the processor is configured to perform step (f) iteratively at a rate selected to minimize execution costs.

30. The system of claim 27, wherein the processor is further configured to perform:
(g) automatically trading additional ones of the block trade opportunities; and
(h) automatically trading additional ones of the buy/sell opportunities to cause closer compliance with the at least one constraint.

31. The system of claim 24, wherein the processor is configured to allow the at least one constraint to comprise a hard constraint.

32. The system of claim 31, wherein the processor is configured to allow the hard constraint to comprise a cash balancing constraint.

33. The system of claim 32, wherein the processor is configured to automatically determine periodically whether the cash balancing constraint is met.

34. The system of claim 31, wherein the processor is configured to allow the at least one constraint to further comprise a soft constraint.

35. The system of claim 34, wherein the processor is configured to allow the soft constraint to comprise an optimization objective.

36. The system of claim 35, wherein the processor is configured such that the optimization objective is based on a cost function.

37. The system of claim 36, wherein the processor is configured such that the cost function is implemented through a look-ahead.

38. The system of claim 25, wherein the processor is configured to give each of the buy/sell opportunities the opportunity score in accordance with whether the buy/sell opportunity meets a plurality of criteria.

39. The system of claim 38, wherein the processor is configured such that the plurality of criteria comprise a price criterion.

40. The system of claim 38, wherein the processor is configured such that the plurality of criteria comprise a participation rate criterion.

41. The system of claim 24, further wherein the processor is configured to provide a graphical user interface to the market participant and is configured to perform step (a) through the graphical user interface.

42. The system of claim 41, wherein the processor is configured such that the graphical user interface allows the market participant to specify the at least one constraint.

43. The system of claim 42, wherein the processor is configured such that the graphical user interface provides a default option for the at least one constraint.

44. The system of claim 42, wherein the processor is configured such that the graphical user interface allows the market participant to control a speed of trading.

45. The system of claim 41, wherein the processor is configured such that the graphical user interface provides a graphical display regarding whether the at least one constraint is met.

46. The system of claim 24, wherein the processor is configured to automatically determine periodically whether the at least one constraint is met.

47. An article of manufacture for trading items, the article of manufacture comprising:
a computer-readable storage medium; and
code stored on the computer-readable storage medium, the code, when executed on a computer system or on a plurality of computer systems on a network, controlling the computer system or systems for:
(a) receiving, from a market participant, a plurality of orders and at least one constraint on execution of said orders;
(b) initiating an automated process to execute said orders using algorithms and/or block markets;
(c) automatically identifying buy/sell opportunities on the computing system or network or on systems in communication with the computing system or network, wherein said buy/sell opportunities are either at a point in time or aggregated over a period of time; and
(d) initiating opportunistic strikes to capture said buy/sell opportunities as needed to enforce said constraints.
